(19) United States
(12) Patent Application Publication
(10) Pub. No.: US 2014/0106160 A1
(43) Pub. Date: Apr. 17, 2014

(54) ANISOTROPIC CONDUCTIVE FILM AND METHOD FOR MANUFACTURING THE SAME

(71) Applicant: HON HAI PRECISION INDUSTRY CO., LTD., New Taipei (TW)

(72) Inventors: CHANG-CHIN WU, New Taipei (TW); PEI-RONG SHIEH, New Taipei (TW)

(73) Assignee: HON HAI PRECISION INDUSTRY CO., LTD., New Taipei (TW)

(21) Appl. No.: 14/030,065

(22) Filed: Sep. 18, 2013

(30) Foreign Application Priority Data
Oct. 12, 2012 (TW) 101137596

(51) Int. Cl. C09J 9/02

(52) U.S. Cl. CPC C09J 9/02
USPC 428/325; 427/58

(57) ABSTRACT

An anisotropic conductive film includes a base board and an insulation adhesive layer coated on a side surface of the base board. The insulation adhesive layer includes a plurality of conductive particles dispersed in the insulation adhesive layer. Each of the plurality of conductive particles includes a spherical base portion, a conductive film formed on the spherical base portion, and an insulation layer with ceramic materials formed on the conductive film. When the conductive particle is being pressed, the insulation layer is capable of being peeled to partly expose the conductive layer. A method for manufacturing the anisotropic conductive film is also provided.

### BACKGROUND

1. Technical Field

The present disclosure relates to a conductive film, and more particularly, to an anisotropic conductive film and a method for manufacturing the same.

2. Description of Related Art

Anisotropic conductive film (ACF) acts as a conductor across the thickness and a insulator through the length. An anisotropic conductive film is used between various terminals for adhesively bonding and electrically connecting. For example, it is used for connection of a driver IC to a liquid crystal panel. In general, an anisotropic conductive film includes a base board and an insulation adhesive layer formed on the base board. Many of conductive particles are dispersed in the insulation adhesive layer. The conventional insulation adhesive layer is coated on the base board directly, so that the conductive particles are distributed randomly in the insulation adhesive layer, and the density and the depth of the conductive particles cannot be defined correctly. When the conventional insulation adhesive layer is being pressed, such as cutting, twisting, some conductive particles in the conventional insulation adhesive layer will gather together in a limited field. As a result, the ACF will create a short in the through direction.

Therefore, there is room for improvement in the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views.

FIG. 1 is a cross-sectional view of an embodiment of an ACF of the present disclosure.

FIG. 2 is a cross-sectional view of a conductive particle of the ACF in FIG. 1.

FIG. 3 is a cross-sectional view of the conductive particle of the ACF in FIG. 2 which is peeled.

FIG. 4 is a flowchart of an embodiment of a method for manufacturing the ACF in FIG. 1.

### DETAILED DESCRIPTION

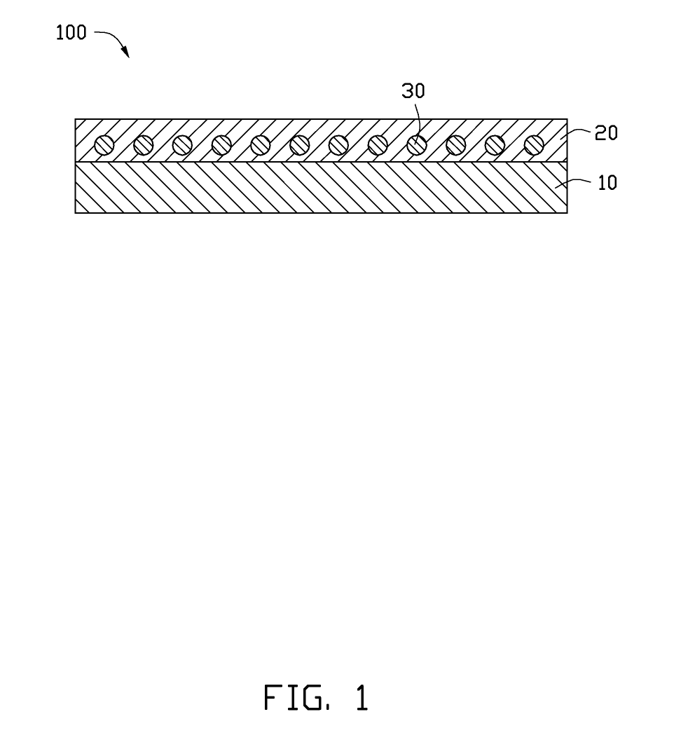

FIG. 1 shows the anisotropic conductive film (ACF) 100 of the embodiment. The ACF 100 includes a base board 10 and an insulation adhesive layer 20 coated on the base board 10. Conductive particles 30 are dispersed in the insulation adhesive layer 20.

The base board 10 is configured to be a carrier/holder for the insulation adhesive layer 20. The base board 10 is made of insulating material. In the illustrated embodiment, the base board 10 is made of polyethylene terephthalate (PET).

The insulation adhesive layer 20 is made of thermosetting resin. In the illustrated embodiment, the insulation adhesive layer 20 is made of epoxy resin.

The conductive particles 30 are distributed evenly in the insulation adhesive layer 20. In the illustrated embodiment, the conductive particles 30 are distributed with monolayer structure in the insulation adhesive layer 20. The conductive particles 30 on a through direction of the ACF are separated from each other. The “through direction” is defined as a direction parallel to surface of the base board 10. A “across the thickness” is defined as a direction perpendicular to the surface of the base board 10.

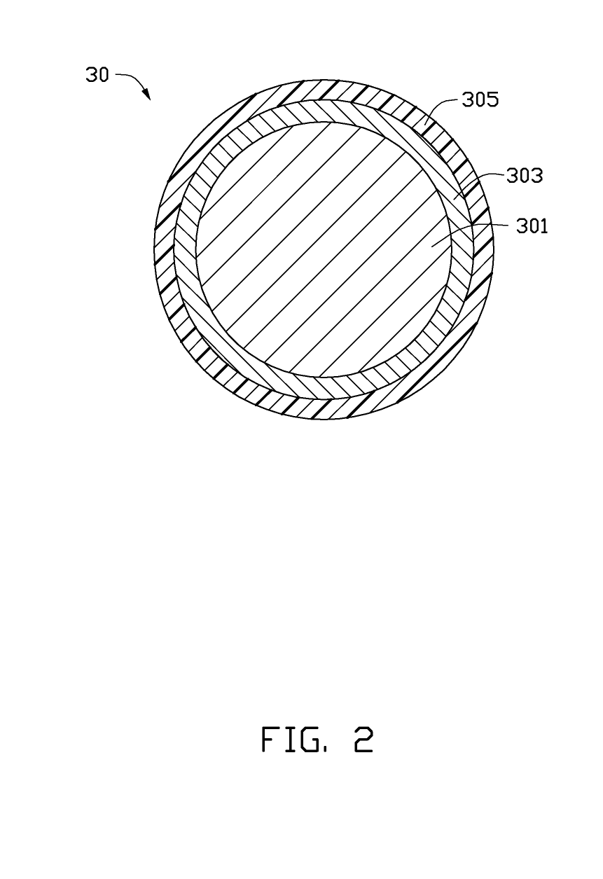

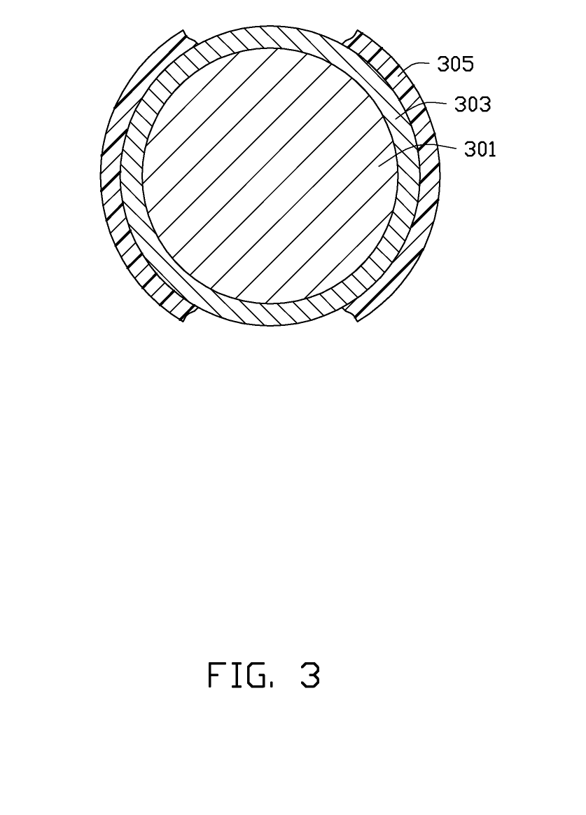

FIG. 2 and FIG. 3 show that the conductive particles 30 including a spherical base portion 301. A conductive layer 303 is formed on the spherical base portion 301 to cover an outer surface of the base portion 301. An insulation layer 305 is formed on the conductive layer 303 to cover an outer surface of the conductive layer 303. That is, the conductive layer 303 is sandwiched between the spherical base portion 301 and the insulation layer 305. The spherical base portion 301 is made of resin, glass, or ceramic, for example. The conductive layer 303 is made of metal, such as nickel (Ni), gold (Au), aluminum (Al) or copper (Cu), for example. The material of the insulation layer 305 including ceramic materials is hard and brittle. When the insulation layer 305 is being forced, it will be peeled to partly expose the conductive film 303.

The insulation layer 305 is made of ceramic materials, such as SiO₂, TiO₂ , Si₃N₄, ZrO₂, or the composition of ceramic materials and insulating resin, such as PET, polybutylene terephthalate (PBT), polyaryletherketone (PEEK), polyetherimide (PEI), polyimide (PI), polytetrafluoroethylene (PTFE), polyurethane(PU) or polycarbonate(PC). In the illustrated embodiment, the spherical base portion 301 is made of resin, the conductive film 303 is made of nickel, and the insulation layer 305 is made of SiO₂.

In use, upper and lower surfaces of the ACF would be squeezed by the liquid crystal panel and the driver IC. Therefore, the upper and lower portions of the insulation layer 305 would be peeled to partly expose the conductive layer 303 due to the external force. As a result, across the thickness of the ACF is conductive. At the same time, the conductive layer 303 of the conductive particles 30 is covered by the insulation layer 305, the conductive particles 30 on the through direction of the ACF become nonconductive preventing a short.

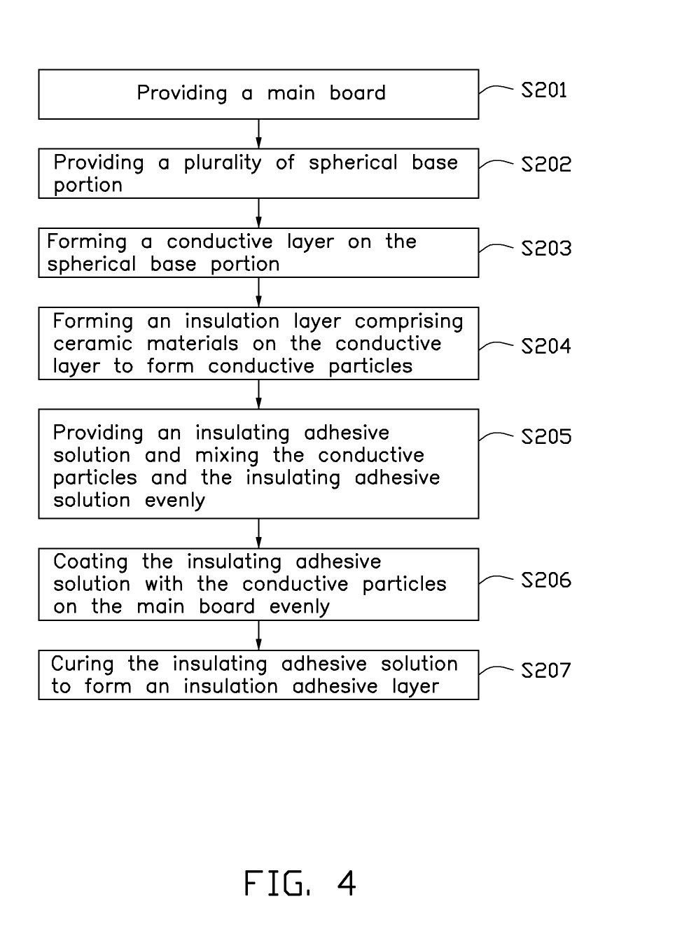

FIG.4 shows an embodiment of a method for manufacturing the ACF is as follows.

In step S201, a base board 10 is provided. In the illustrated embodiment, the base board 10 is made of PET.

In step S202, a lot of spherical base portions 301 are provided. The spherical base portion 301 is made of resin, glass or ceramic. In the illustrated embodiment, the spherical base portion 301 is made of glass.

In step S203, a conductive layer 303 is formed on the spherical base portion 301 to cover the whole outer surface of the base portion 301. The spherical base portion 301 is made of metal, such as Ni, AU, Al and Cu. The spherical base portion 301 is made by physicochemical process, such as coating method, chemical reduction method, or electrochemical machining method. In the illustrated embodiment, the conductive layer 303 is a metal layer made by chemical reduction method. The temperature is controlled between 110° C. and 130° C. The base board 301 is dissolved in the solution containing 0.1 mol/L of HAuCl₄ and 0.03 mol/L of sodium citrate for 30 minutes, thus a gold layer with a thickness of about 20 μm-about 40 μm forms on the surface of the base board 301.

In step S204, an insulation layer 305 comprising ceramic materials is formed on the conductive layer 303 to cover the whole outer surface of the conductive layer 303. Therefore, a conductive particle 30 is completed. The insulation layer 305 is made of ceramic materials, such as SiO₂, TiO₂ , Si₃N₄ and ZrO₂. The insulating layer 305 can be formed by sol-gel method, co-precipitation or hydrothermal, but not limited to these methods. The insulation layer 305 is made of the composition of ceramic materials and insulating resin such as PET, PBT, PEEK, PEI, PI, PTFE, PU or PC. There is a polymerization reaction after modification on the conductive layer 303. At first, the ceramic particles are dispersed in the insulation resin monomers. Then, there is a polymerization reaction on the surface of the conductive layer 303. The volume of the insulation layer 305 is from 0.1 to 70 percent of the spherical base portion 301. In the illustrated embodiment, the insulation layer 305 is made of SiO₂. Take the sol-gel method as example, dispersing the spherical base portion 301 covered by the conductive film 303 into the solution comprising tetraethylorthosilicate (TEOS) as initiators, and through the reactions of hydrolysis and condensation to form an insulation layer 305 on the conductive film 303. The optimum volume of the insulation layer 305 is from 0.2 to 70 percent of the spherical base portion 301.

In step S205, an insulating adhesive solution is provided, and then the conductive particles 30 and the insulating adhesive solution is evenly mixed. In the illustrated embodiment, the insulating adhesive solution is epoxy resin solution.

In step S206, the mixture of the conductive particles 30 and the insulating adhesive solution are coated on the main board 10. In the illustrated embodiment, the conductive particles 30 are coated on the main board 10 evenly with a monolayer structure.

In step S207, an insulation adhesive layer 20 is formed by curing the insulating adhesive solution. In the illustrated embodiment, the epoxy resin is a thermosetting resin. The epoxy resin is cured by the thermosetting method.

The conductive particles 30 of the ACF 100 according to the embodiment of the present disclosure include a insulation layer 305 coated on the surface of the conductive layer 303. As the insulation layer 305 is made of ceramic materials or the composition of the ceramic materials and insulating resin, the insulation layer 305 is brittle and easy to rupture. In use, the upper and lower surface of the ACF 100 is being forced causing the upper and lower portions of the insulation layer 305 to peeled and partly expose the conductive layer 303. As the result, across the thickness of the ACF is conductive. At the same time the insulation layer 305 covers the conductive layer 303, the conductive particles 30 on the through direction of the ACF become nonconductive preventing a short.

It is believed that the present embodiments and their advantages will be understood from the foregoing description, and it will be apparent that various changes may be made thereto without departing from the spirit and scope of the embodiments or sacrificing all of its material advantages.

What is claimed is:

1. An anisotropic conductive film (ACF), comprising:
a base board, and
an insulation adhesive layer coated on a side surface of the base board, the insulation adhesive layer having a plurality of conductive particles dispersed in it;
wherein the conductive particles comprises a spherical base portion, a conductive layer formed on the spherical base portion, and an insulation layer formed on the conductive layer;
wherein material of the insulation layer comprises ceramic materials, when the conductive particle is being pressed, the insulation layer is capable of being peeled to partly expose the conductive layer.

2. The ACF as claimed in claim 1, wherein the ceramic materials is SiO2, TiO2 , Si3N4 or ZrO2.

3. The ACF as claimed in claim 1, wherein the insulation layer further comprises insulating resin.

4. The ACF as claimed in claim 1, wherein the insulation layer is a ceramic layer, and the volume of the ceramic layer is 0.1 to 70 percent of the spherical base portion.

5. A method of manufacturing an anisotropic conductive film (ACF), comprising:
providing a main board;
providing a plurality of spherical base portion;
forming a conductive layer on the spherical base portion;
forming an insulation layer comprising ceramic materials on the conductive layer to form conductive particles;
providing an insulating adhesive solution and mixing the conductive particles and the insulating adhesive solution;
coating the insulating adhesive solution with the conductive particles on the main board uniformly; and
curing the insulating adhesive solution to form an insulation adhesive layer.

6. The method of manufacturing an ACF as recited in claim 5, wherein the insulation layer comprises insulating resin.

7. The method of manufacturing an ACF as recited in claim 5, wherein the insulation layer is a ceramic layer and the volume of the ceramic layer is 0.1 to 70 percent of the spherical base portion.

8. The method of manufacturing an ACF as recited in claim 7, wherein the ceramic layer in made by sol-gel method.

9. The method of manufacturing an ACF as recited in claim 5, wherein the conductive layer is made by coating method.
